(19) United States
(12) Patent Application Publication
(10) Pub. No.: US 2006/0077485 A1
(43) Pub. Date: Apr. 13, 2006

(54) Image forming apparatus

(75) Inventor: Eun-Young Baek, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/156,525

(22) Filed: Jun. 21, 2005

(30) Foreign Application Priority Data
Oct. 9, 2004 (KR) 10-2004-0080725

(51) Int. Cl. H04N 1/04

(52) U.S. Cl. 358/498; 358/474

(57) ABSTRACT

An image forming apparatus is provided in which a printing part is provided for printing an image on paper and a scanning part is positioned beside the printing part. A main circuit board is disposed therebetween. The main circuit board is provided with an image processor to process image data. The scanning part includes a scanner for scanning an image of a document, a document feeder for feeding the document to the scanner, and a document discharger for ejecting the document after scanning the image. The scanner is aligned to scan the image of the document that is vertically conveyed in a lengthwise direction.

### CROSS REFERENCE TO RELATED APPLICATION

This application claims the priority under 35 U.S.C. § 119 (a) of Korean Patent Application No. 10-2004-0080725, filed on Oct. 9, 2004, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image forming apparatus capable of printing an image on paper and scanning an image of an original.

2. Description of the Related Art

Typical image forming apparatuses print a visible image on paper with received image data. In recent years, there has been vigorous research into image forming apparatuses that extract digital image data from a document and output the image data on a display or paper. That is, such image forming apparatuses combine the functions of a printer, scanner, facsimile, and the like, and thus are called “multifunctional printing device”.

FIG. 1 is a perspective view of a conventional image forming apparatus capable of image scanning.

Referring to FIG. 1, an image forming apparatus 10 includes a scanning part 30 at an upper portion to extract an image from a document and a printing part 20 under the scanning part 30.

During operation of the printing part 20, paper is picked up one by one from a cassette 22 into the printing part 20, a toner image is transferred and fused on the paper, and then the paper is ejected to a paper output tray 25. Since the paper is heated during the fusing step, the ejected paper emits heat. The heat emitted from the ejected paper is not readily released from the paper output tray 25 due to the narrow space of the paper output tray 25, thereby increasing the temperature around the paper output tray 25. Therefore, parts around the paper output tray 25 are deteriorated and deformed by the heat. Also, since an image sensor (not shown) of the scanning part, such as a contact image sensor (CIS) or a charge coupled device (CCD), is placed near the paper output tray 25, it may also be deteriorated by the heat.

Meanwhile, the image forming apparatus 10 uses a cable or a harness to connect a main circuit board with a sub-circuit board on which the sensor is mounted. However, the extracted image data is damaged by noise as it is transmitted via the cable or harness, and also the cable or harness causes undesirable electromagnetic wave.

Accordingly, a need exists for an improved image forming apparatus that substantially prevents the detrimental effects of heat from fusing an image onto paper.

### SUMMARY OF THE INVENTION

The present invention provides an image forming apparatus in which a scanning part is positioned beside a printing part.

Also, the present invention provides an image forming apparatus in which an image sensor of a scanning part is electrically connected to a main circuit board without a harness or a cable.

According to an aspect of the present invention, an image forming apparatus includes a printing part for printing an image on paper, and a scanning part positioned beside the printing part with a main circuit board disposed therebetween. The main circuit board has an image processor to process an image data. The scanning part includes a scanner for scanning an image of a document, a document feeder for feeding the document to the scanner, and a document discharger for ejecting the document after the scanning the image. The scanner is aligned to scan the image of the document that is vertically conveyed in a lengthwise direction.

The document feeder may be positioned at an upper portion of the scanning part. The document discharger may positioned at a lower portion of the scanning part. The scanner may be positioned between the document feeder and the document discharger, such that the document may be conveyed downwardly.

The document feeder may include a document feed tray in which the document to be scanned is stored at a steep angle in a lengthwise direction.

The document discharger may include a document output tray to which the scanned document is discharged and stored substantially horizontally.

The scanner may include an image sensor mounted on the main circuit board.

The scanner may include a sub-circuit board linked with the main circuit board by a connector and an image sensor mounted on the sub-circuit board.

The printing part may include a printer for printing an image on paper, a paper feeder for feeding the paper to the printer, and a paper discharger for ejecting the paper after printing on the paper. The paper discharger is positioned above the paper feeder and the printer.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view of a conventional image forming apparatus;

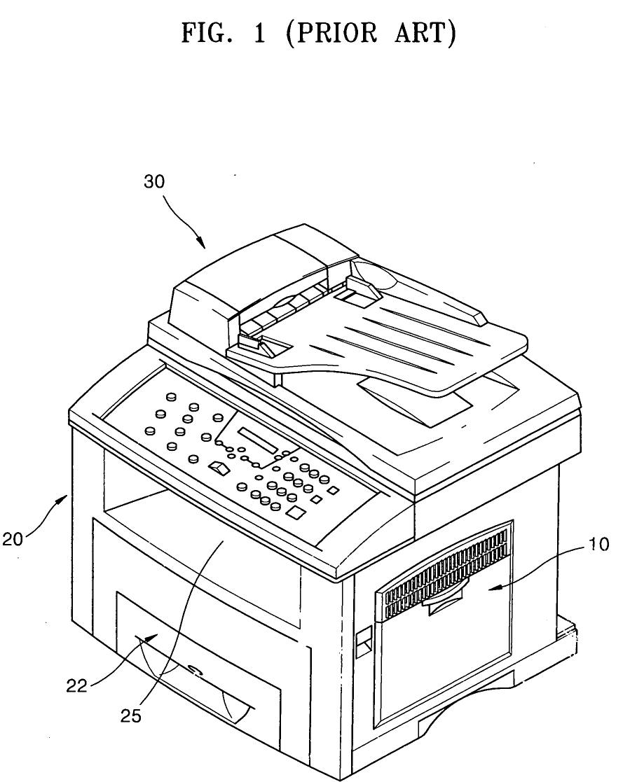

FIG. 2 is a perspective view of an image forming apparatus according to an exemplary embodiment of the present invention;

FIG. 3 is an elevational view in partial cross section of a printing part of an image forming apparatus of FIG. 2;

FIG. 4 is an elevational view in partial cross section of a scanning part of an image forming apparatus of FIG. 2; and

FIG. 5 is an elevational view in partial cross section of a scanning part of an image forming apparatus according to another exemplary embodiment of the present invention.

Throughout the drawings, like reference numerals will be understood to refer to like parts, components and structures.

### DETAILED DESCRIPTION OF EXEMPLARY EMBODIMENTS

The present invention will now be described more fully with reference to the accompanying drawings, in which exemplary embodiments of the invention are shown.

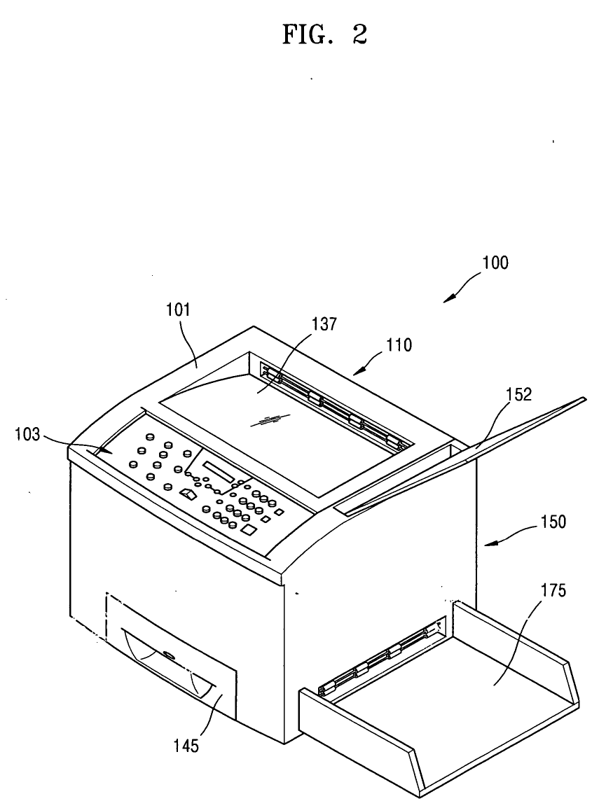

FIG. 2 is a perspective view of an image forming apparatus according to an exemplary embodiment of the present invention.

Referring to FIG. 2, an image forming apparatus 100 includes an outer case 101 made by a plastic molding with a hexahedral shape, a printing part 110 for printing an image, a scanning part 150 for extracting image data from a document, a paper output tray 137 on an upper side of the outer case 101 to receive printed paper, and a control panel 103 at an upper side of the outer case 101. The printing part 110 and scanning part 150 are preferably disposed side by side in the outer case 101.

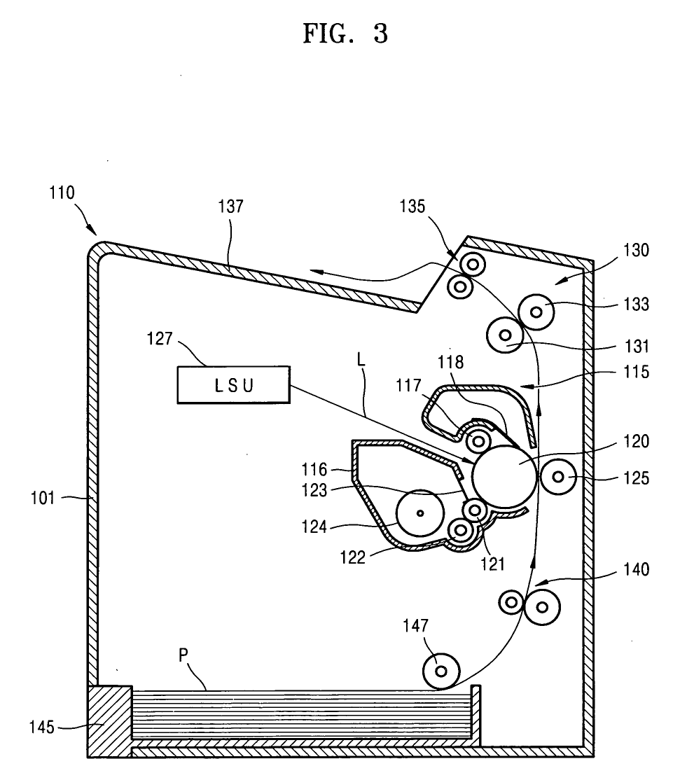

FIG. 3 is an elevational view in partial cross section of a printing part of an image forming apparatus of FIG. 2.

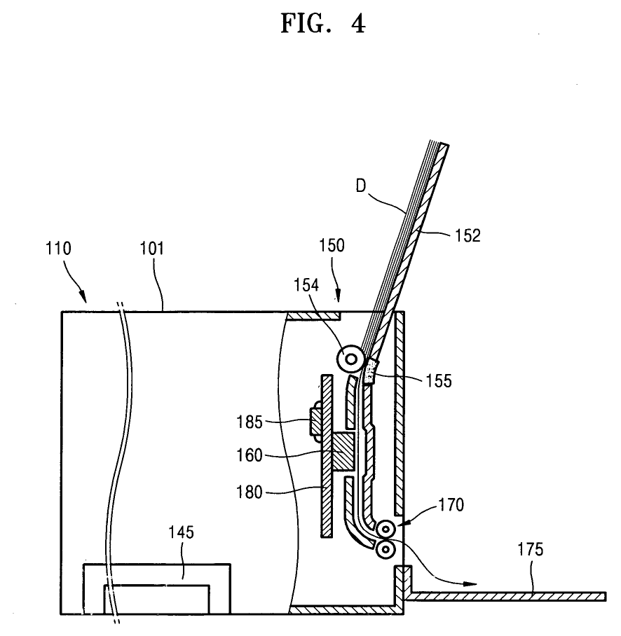

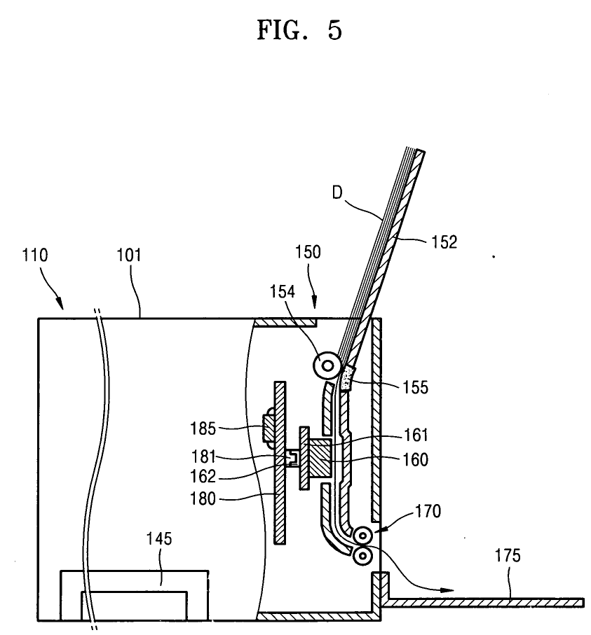

Referring to FIG. 3, paper (P) is conveyed along a substantially “C”-shaped path in the printing part 110. The printing part 110 includes a printer for printing an image on the paper (P), a paper feeder for conveying the paper (P) to the printer, and a paper discharger for discharging the paper (P) after printing. The printer includes a development unit 115 detachably installed in the outer case 101, a fuser 130, and a laser scanning unit (LSU) 127. The paper feeder includes a cassette 145, a pick-up roller 147, and paper registrator 140. The paper discharger includes eject rollers 135 and the paper output tray 137. Also, the printing part 110 includes a print controller for controlling the printer, the paper feeder, and the paper discharger during print operation. The print controller includes a main circuit board 180 on which an image processor 185 is mounted to process image data corresponding to a print image (FIGS. 4 and 5).

The development unit 115 includes a housing 116, a photosensitive medium 120, a charger 117, a waste toner cleaner 118, a development roller 121, a doctor blade 123, a toner feed roller 122, and an agitator 124. The housing 116 contains toner. The photosensitive medium 120 forms an electrostatic latent image thereon when exposed to light. The charger 117 charges the photosensitive medium 120. The waste toner cleaner 118 removes waste toner from the photosensitive medium 120. The development roller 121 applies the toner to the electrostatic latent image formed on an outer surface of the photosensitive medium 120 to form a visible toner image thereon. The doctor blade 123 regulates the thickness of the toner on the development roller 121. The toner feed roller 122 supplies the toner to the development roller 121. The agitator 124 stirs the toner of the housing 116 to prevent hardening of the toner. The development unit 115 is constructed in the form of a cartridge, such that the development unit 115 may be easily replaced with a new one when its supply of toner is used up.

The transfer roller 125 and the photo sensitive medium 120 are engaged by pressure and may be applied with a transfer bias voltage, such that when the paper (P) passes between the transfer roller 125 and the photo sensitive medium 120, the toner image on the outer surface of the photo sensitive medium 120 is transferred to the paper (P) by the pressure acting therebetween or the applied transfer bias voltage.

The fuser 130 includes a pair of rollers, a heat roller 131 and a pressure roller 133, that are engaged. As the paper (P) passes between the rollers 131 and 133, the transferred image on the paper (P) is fused and securely attached on the paper (P) by the heat and pressure of the fuser 130.

The pick-up roller 147 picks up the paper (P) one by one from the cassette 145. The picked up paper (P) is precisely fed to the photosensitive medium 120 by the paper registrator 140 such that the toner image on the photosensitive medium 120 is precisely transferred to a selected area of the paper (P).

The operation of the printing part 110 will now be described. The charger 117 charges the photosensitive medium 120 to have a selected electric potential. The LSU 127 applies a light beam L to the charged photosensitive medium 120 to form an electrostatic latent image corresponding to a print image on the outer surface of the photosensitive medium 120. The toner in the housing 116 is applied to the electrostatic latent image of the photosensitive medium 120 through the toner feed roller 122 and the development roller 121, such that a visible toner image is formed on the outer surface of the photosensitive medium 120. The pick-up roller 147 picks up paper (P) from the cassette 145. The paper registrator 140 feeds the picked up paper (P) toward the photosensitive medium 120 and the transfer roller 125 in a proper feeding direction. As the photosensitive medium 120 and the transfer roller 125 rotate, the visible toner image is transferred to the paper (P) as it passes between the photosensitive medium 120 and transfer roller 125. That is, the visible toner image of the photosensitive medium 120 is transferred to one side of the paper facing the photosensitive medium 120. When the paper (P) passes through the fuser 130, the fuser 130 applies heat and pressure to the paper (P) to securely attach the transferred image on the paper (P) by fusing the image. After that, the paper (P) is ejected to the paper output tray 137 by the eject rollers 135.

FIG. 4 is an elevational view in partial cross section of a scanning part of an image forming apparatus of FIG. 2.

Referring to FIG. 4, the scanning part 150 and the printing part 110 are preferably located side by side. The main circuit board 180 is disposed between the scanning part 150 and the printing part 110. The scanning part 150 includes a scanner for extracting an image from a document (D), a document feeder for feeding the document (D) to the scanner, and a document discharger for ejecting the scanned document (D). Also, the scanning part 150 includes a scan controller to control the scanner, the document feeder, and the document discharger during the operation of the scanning part 150. The scan controller and the print controller share the image processor 185 and the main circuit board 180.

The scanner includes an image sensor 160, such as a contact image sensor (CIS) or a charge coupled device (CCD). The image sensor 160 is directly mounted on the main circuit board 180 by bonding or the like. The image sensor 160 is preferably disposed lengthwise between the document feeder and the document discharger, such that the image sensor 160 may scan an image on one side of a document that is fed downwardly.

FIG. 5 is an elevational view in partial cross section of a scanning part of an image forming apparatus according to another exemplary embodiment of the present invention.

Referring to FIG. 5, the scanner may include the image sensor 160 and a sub-circuit board 161 on which the image sensor 160 is mounted. Since the sub circuit board 161 and the main circuit board 180 are close and parallel to each other, they may be connected using a simple connector instead of using a relatively complicated harness or cable. For example, a pair of a male connector 181 and a female connector 162 may be formed on the main circuit board 180 and the sub circuit board 161, respectively, for connecting the sub-circuit board 161 and the main circuit board 180. Therefore, the image sensor 160 may be connected to the main circuit board 180.

The document feeder located at an upper portion of the image forming apparatus 100 is provided with a document feed tray 152 for storing a stack of a documents and an automatic document feed (ADF) roller 154 for feeding the documents (D) one by one. The document feed tray 152 is preferably inclined almost vertically to align leading ends of the documents (D) by gravity, thereby reducing skewed positioning of the documents (D). The ADF roller 154 abuts an ADF pad 155, such that as the ADF roller 154 rotates, the document (D) is fed one by one toward the image sensor 160.

The document discharger located at a lower portion of the image forming apparatus 100 is provided with eject rollers 170 for ejecting the document (D) out of the case 101 after scanning. A horizontally extended document output tray 175 stores the ejected document (D).

During operation of the scanning part 150, when a scanning order is inputted, the document (D) on the document feed tray 152 is fed separately in a downward direction between the ADF roller 154 and the ADF pad 155. Then the document (D) passes along the image sensor 160 for image scanning one side of the document (D). After that, the eject rollers 170 eject the document (D) to the document output tray 175.

The image forming apparatus of the exemplary embodiments of the present invention provide several advantages.

First, the scanning part is positioned beside the printing part to obviate the spatial restriction of the paper output tray of the printing part, such that the heat in the paper output tray is easily transferred to the surroundings, thereby reducing the degradation and deformation of the peripheral elements.

Second, the closely positioned relationship between the image sensor and the main circuit board allows using of a relatively short connecting means instead of a long connecting means such as a harness or a cable, such that the scanned image data is substantially protected from the noise and the generation of electromagnetic waves is substantially prevented.

Third, according to an exemplary embodiment of the present invention, the documents to be scanned are stored on the inclined document feed tray such that the leading edges of the documents are aligned without additional alignment means, and the path of the documents is substantially straightened and shortened to allow miniaturization of the image forming apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus, comprising:
a printing part for printing an image on paper;
a scanning part positioned beside the printing part, the scanning part including
a document feeder for feeding a document to a scanner;
a scanner for scanning an image of the document, the scanner being aligned to scan the image of the document conveyed from the document feeder in a substantially vertical direction; and
a document discharger for ejecting the document after the image is scanned;
a main circuit board disposed between the scanning part and the printing part; and
an image processor mounted on the main circuit board to process image data.

2. The image forming apparatus of claim 1, wherein
the document feeder is positioned at an upper portion of the scanning part, the document discharger is positioned at a lower portion of the scanning part, and the scanner is positioned between the document feeder and the document discharger such that the document is conveyed downwardly.

3. The image forming apparatus of claim 2, wherein
the document feeder has a document feed tray in which the document to be scanned is stored at a steep angle.

4. The image forming apparatus of claim 3, wherein
the document to be scanned is stored in a lengthwise direction.

5. The image forming apparatus of claim 2, wherein
the document discharger has a document output tray to which the scanned document is discharged and stored in a substantially horizontally.

6. The image forming apparatus of claim 1, wherein
the scanner has an image sensor mounted on the main circuit board.

7. The image forming apparatus of claim 1, wherein
a sub-circuit board is connected to the main circuit board; and
an image sensor is mounted on the sub-circuit board.

8. The image forming apparatus of claim 7, wherein
the main circuit board and the sub-circuit board are substantially parallel.

9. The image forming apparatus of claim 8, wherein
the image sensor is mounted on a side of the sub-circuit board facing away from the main circuit board.

10. The image forming apparatus of claim 7, wherein
a connector connects the sub-circuit board to the main circuit board.

11. The image forming apparatus of claim 7, wherein
the main circuit board has a first connector mounted thereon and the sub-circuit board has a second connector mounted thereon, one of the first and second connectors is a male connector and the other is a corresponding female connector.

12. The image forming apparatus of claim 1, wherein
the printing part includes
a printer for printing the image on the paper;
a paper feeder for feeding the paper to the printer; and
a paper discharger for ejecting the paper after the printer prints on the paper.

13. The image forming apparatus of claim 12, wherein
the paper discharger is positioned above the paper feeder and the printer.

14. An image forming apparatus, comprising:
a printing part for printing a first image on a paper;
a scanning part positioned beside the printing part to scan a second image on a document;
a main circuit board disposed between the scanning part and the printing part;
an image processor mounted on the main circuit board to process image data;
a sub-circuit board connected to the main circuit board; and
an image sensor mounted on the sub-circuit board.

15. The image forming apparatus of claim 14, wherein
the main circuit board and the sub-circuit board are substantially parallel.

16. The image forming apparatus of claim 15, wherein
the image sensor is mounted on a side of the sub-circuit board facing away from the main circuit board.

17. The image forming apparatus of claim 16, wherein
the main circuit board has a first connector mounted thereon and the sub-circuit board has a second connector mounted thereon, one of the first and second connectors is a male connector and the other is a corresponding female connector that mates with the male connector.

18. The image forming apparatus of claim 14, wherein
the scanning part includes
a document feeder for feeding the document to a scanner;
a scanner for scanning the second image of the document, the scanner being aligned to scan the image of the document conveyed from the document feeder in a substantially vertical direction; and
a document discharger for ejecting the document after the second image is scanned.

19. The image forming apparatus of claim 18, wherein
the printing part includes
a printer for printing the first image on the paper;
a paper feeder for feeding the paper to the printer; and
a paper discharger for ejecting the paper after the printer prints the first image on the paper.

20. The image forming apparatus of claim 19, wherein
the document feeder is positioned at an upper portion of the scanning part, the document discharger is positioned at a lower portion of the scanning part, and the scanner is positioned between the document feeder and the document discharger such that the document is conveyed downwardly; and
the paper discharger is positioned above the paper feeder and the printer.
